(19) United States
(12) Patent Application Publication
(10) Pub. No.: US 2022/0340380 A1
(43) Pub. Date: Oct. 27, 2022

(54) HIGHLY-EFFICIENT COMPONENTS SUPPLYING SYSTEM

(71) Applicant: A-TECH SYSTEM CO., LTD., Taichung City (TW)

(72) Inventor: HUNG-CHIH YANG, Taichung City (TW)

(21) Appl. No.: 17/387,244

(22) Filed: Jul. 28, 2021

(30) Foreign Application Priority Data
Apr. 26, 2021 (TW) 110114921

(51) Int. Cl. B65G 69/04; B65G 47/38

(52) U.S. Cl. CPC B65G 69/0425; B65G 47/38

(57) ABSTRACT

A highly-efficient components supplying system for transporting and feeding multiple components includes a platform unit which has a placement surface, a vibration generating unit including a plurality of vibration actuating members which are spaced apart from each other to be operative to vibrate the placement surface, and a centrifugal actuating unit operative to make synchronous rotation of the base seat, the vibration generating unit and the platform unit. When the vibration actuating members vibrate the placement surface, the components are moved upwardly away from the placement surface. With the rotation of the platform unit by the centrifugal actuating unit, the components falling on the placement surface are moved again and turned to facilitate further disentangling and separation thereof and to have a required posture for feeding processes. An optimized operation can be selected according to the characteristics and distribution of the components.

### CROSS-REFERENCE TO RELATED APPLICATION

This application claims priority of Taiwanese Patent Application No. 110114921, filed on Apr. 26, 2021.

### FIELD

The disclosure relates to a mechanical apparatus, and more particularly to a highly-efficient components supplying system.

### BACKGROUND

A conventional components supplying equipment includes a table, a conveyor unit for conveying multiple components to the table, and a vibrating unit disposed to the table. The components are conveyed onto the table from the conveyor unit, and the vibrating unit is enabled to vibrate the table vertically to separate the overlapping components from one another for a robot to grasp the components one by one and perform subsequent processing operations. However, such conventional supplying equipment cannot be used efficiently in the field of small components since small components are light weighted, and electrostatic interaction between the components generates adhesion that makes suitable separation of the components difficult.

Moreover, when some components need to be processed in specific orientation or on specific processing surfaces during subsequent processing, the aforesaid conventional supplying equipment can be used for turning over large-sized components through vertical vibration, but is difficult for turning over small-sized or thin-walled components to present the required postures favorable to be grasped by the robot.

### SUMMARY

Therefore, an object of the disclosure is to provide a highly-efficient components supplying system that can alleviate at least one of the drawbacks of the prior art.

According to the disclosure, the highly-efficient components supplying system for transporting and feeding a plurality of components includes a platform unit which has a placement surface for placement of the components and regarding which an axis is normal to the placement surface, a vibration generating unit which includes a plurality of vibration actuating members that are disposed on the platform unit and spaced apart from each other, and that are each operative to vibrate the placement surface in an extending direction of the axis, a base seat which is spaced apart from the platform unit in the extending direction and on which the vibration actuating members are disposed, and a centrifugal actuating unit which is disposed on the base seat and which is operative to make a synchronous rotation of the base seat, the vibration generating unit and the platform unit about the axis.

With the vibration actuating members and the centrifugal actuating unit, when each vibration actuating member is operated to vibrate the placement surface, the components are moved upwardly away from the placement surface temporarily. With the rotation of the platform unit by the centrifugal actuating unit, the components falling again on the placement surface are moved again and turned to facilitate further disentangling and separation thereof and to have a required posture for feeding processes. Moreover, since the vibration actuating members and the centrifugal actuating unit are operable individually and independently, an optimized operation can be selected according to the characteristics and distribution of the components.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an embodiment of a highly-efficient components supplying system according to the disclosure;

FIG. 2 is a perspective view of the embodiment taken from another angle;

FIG. 3 is a schematic view of the embodiment, illustrating a state when a component is turned over to present a required posture;

FIGS. 4a and 4b are schematic views of the embodiment, illustrating a state when multiple components are vibrated to be disentangled and separated from one another;

FIGS. 5a, 5b and 5c are schematic perspective views of the embodiment, illustrating a state when multiple components are rotated to be disentangled and separated from one another;

FIGS. 6a and 6b are schematic side views of a first comparative example, illustrating a state when multiple components placed on the first comparative example are vibrated only in a vertical direction; and

FIGS. 7a and 7b are schematic top views of a second comparative example, illustrating a state when multiple components placed on the second comparative example are rotated only about a vertical axis.

### DETAILED DESCRIPTION

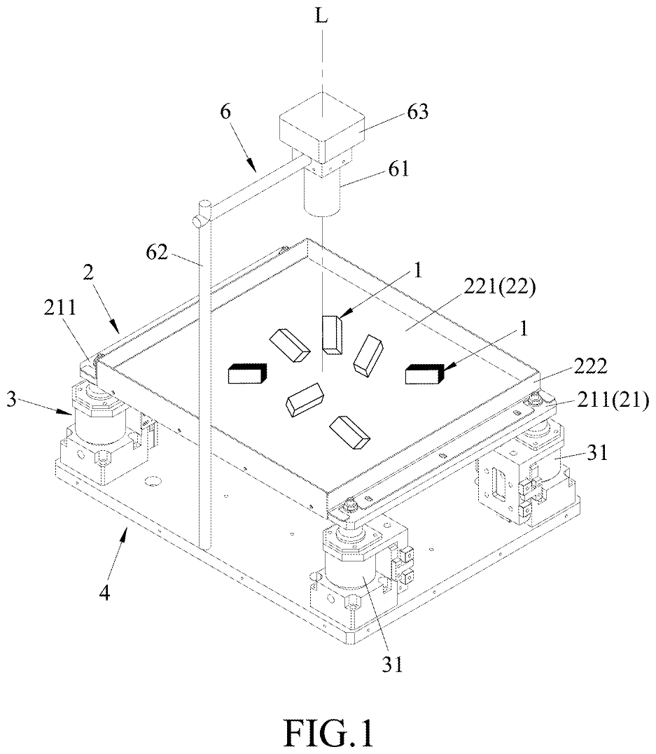

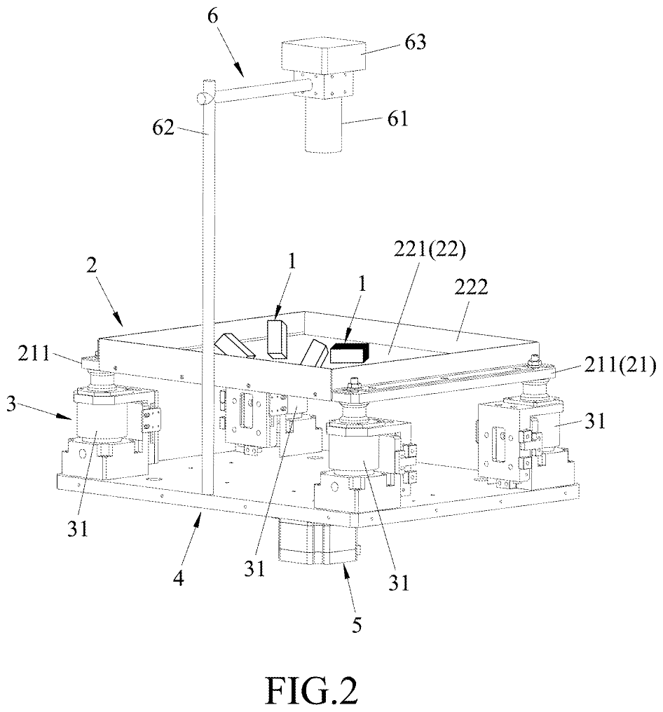

Referring to FIGS. 1 and 2, an embodiment of a highly-efficient components supplying system for transporting and feeding a plurality of components 1 includes a platform unit 2, a vibration generating unit 3, a base seat 4, a centrifugal actuating unit 5 and a sensing and control unit 6.

The platform unit 2 includes a base plate 21 and a placement table 22 which is mounted upon the base plate 21. The placement table 22 has a placement surface 221 for placement of the components 1 and a surrounding wall 222 surrounding and extending upwardly from a periphery of the placement surface 221. An axis (L) is defined normal to the placement surface 221. In this embodiment, the placement surface 221 is a horizontal plane, but is not limited to this. The base plate 21 has two lateral flange portions 211 which project laterally from two opposite sides of the placement table 22, respectively.

The vibration generating unit 3 includes four vibration actuating members 31 which are disposed on the platform unit 2 and spaced apart from one another. In this embodiment, the vibration actuating members 31 are disposed under the platform unit 2 and are angularly spaced apart from each other about the axis (L). Two of the vibration actuating members 31 are connected with a respective one of the lateral flange portions 211 of the base plate 21. Each vibration actuating member 31 is operative to vibrate the placement surface 221 in an extending direction of the axis (L). Specifically, each vibration actuating member 31 is operative to vibrate individually the placement surface 221 at the region corresponding with the position thereof, and may be of anyone of various motors, such as a linear motor, a voice coil motor (VCM), and a vibrating motor, or in the form of a pneumatic cylinder, or of other techniques.

The base seat 4 is disposed under the platform unit 2, and is spaced apart from the platform unit 2 in the extending direction for the vibration actuating members 31 to be disposed thereon. Each of the vibration actuating members 31 is interposed between and connected between the base seat 4 and the base plate 21 of the platform unit 2.

The centrifugal actuating unit 5 is disposed on and under the base seat 4, and is operative to make a synchronous rotation of the base seat 4, the vibration generating unit 3 and the platform unit about the axis L. In this embodiment, the centrifugal actuating unit 5 is a rotating motor, but is not limited to this.

The sensing and control unit 6 is arranged to correspond with the placement surface 221 to detect and measure distribution and orientation of the components 1 placed on the placement surface 221 and generate a corresponding distribution information. The sensing and control unit 6 includes a camera 61 which is disposed above the placement surface 221 to fetch images of the placement surface 221, a suspending arm 62 which extends upwardly from the base seat 4 and suspends above the placement surface 221 for supporting the camera 61, and a processor 63 in signal connection with the camera 61, the vibration generating unit 3 and the centrifugal actuating unit 5.

The processor 63 is arranged to analyze the images fetched by the camera 61 and generate the distribution information, and controls operations of the vibration actuating members 31 and the centrifugal actuating unit 5 in accordance with the distribution information in either sequential or synchronous manner. The distribution information includes distributed positions and orientations of the components 1, and postures of the components 1 whether to present the required postures for feeding operations (for example, the position favorable to be grasped by a robot, the posture to be turned over for subsequent processing operations, and so on).

When the highly-efficient components supplying system is in operation, the components 1 are first placed on the placement surface 221, and the camera 61 fetches images of the placement surface 221. The processor 63 analyzes the images and generates distribution information, and controls operations of the vibration actuating members 31 and the centrifugal actuating unit 5 in accordance with the distribution information in either sequential or synchronous manner so as to permit the placement surface 221 to be vibrated at the corresponding region in the extending direction of the axis (L), and so as to permit the placement surface 221 to be rotated about the axis (L).

Additionally, the camera 61 continuously fetches images of the placement surface 221 for the processor 63 to continuously analyze the distribution information of the components 1 and to determine whether the components 1 present the required postures. The operation strokes of the vibration actuating members 31 and the centrifugal actuating unit 5 are adjusted accordingly. The vibration actuating members 31 and the centrifugal actuating unit 5 continue to operate until the distribution and posture of the components 1 are suitable for being grasped by the robot. The operations of the vibration actuating members 31 and the centrifugal actuating unit 5 are then stopped.

Furthermore, the processor 63 also controls the vibration actuating members 31 and the centrifugal actuating unit 5 to operate independently and individually according to the images of the placement surface 221. For example, when the processor 63 determines that the components 1 are gathered at a region above a certain one of the vibration actuating members 31, the processor 63 drives the corresponding vibration actuating member 31 to operate independently and stops the operation of the other vibration actuating members 31 so as to disperse the gathered components 1. During the continuous operations of the vibration actuating members 31 and the centrifugal actuating unit 5, the processor 63 also continuously analyzes the distribution and orientation of the components 1, and is stopped temporarily when the processor 63 determines the positions and postures of the components 1 as reaching a predetermined condition that meets the feeding requirement. At the same time, the processor 63 controls and temporarily stops the operations of the vibration actuating members 31 and the centrifugal actuating unit 5 for a robot (not shown) to perform grasp of the components 1. After the robot completes the grasp operation, the processor 63 controls and resumes the operations of the vibration actuating members 31 and the centrifugal actuating unit 5.

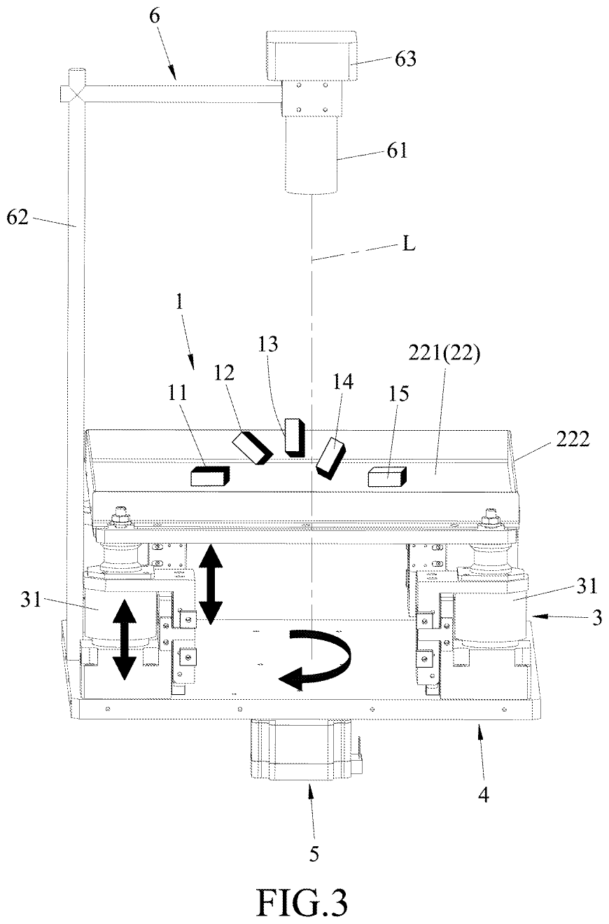

FIG. 3 illustrates the operation of the highly-efficient components supplying system to disentangle and separate the components 1 and to turnover the components 1 to the posture required for feeding processes. One of the components 1 is taken as an example. In FIG. 3, regarding the process of turning the component 1 on the placement surface 221 from the left to the right, the different positions in the turning process marked with references 11, 12, 13, 14 and 15 according to the time sequence are shown. The three side surfaces of the component 1 are drawn in black (taking the component 1 of reference 11 as an example, the sides presentable in black are the left, upper and right side surfaces of the component 1, but the left side surface is not shown), and the other three side surfaces are drawn in white. It is required to have a posture where one side surface of the component 1 drawn in white faces upward.

Firstly, when the component 1 is located at the position referenced 11, the two vibration actuating members 31 on the left side of FIG. 3 are operated to vibrate the placement surface 221. With a clockwise torque generated as a result of the relative position of the component 1 and the vibrated location, the component 1 is moved upwardly from the position 11 away from the placement surface 221 for a short time, and then is rotated to the positions 12, 13 and 14 in sequence. When the component 1 moves to the position 14 and falls on the placement surface 221 again, the centrifugal actuating unit 5 actuates a rotation of the placement surface 221 such that the component 1 is turned over to the position 15, and has the posture where the side surface of the component 1 drawn in white faces upwards. Hence, the component 1 has the required posture for feeding processes.

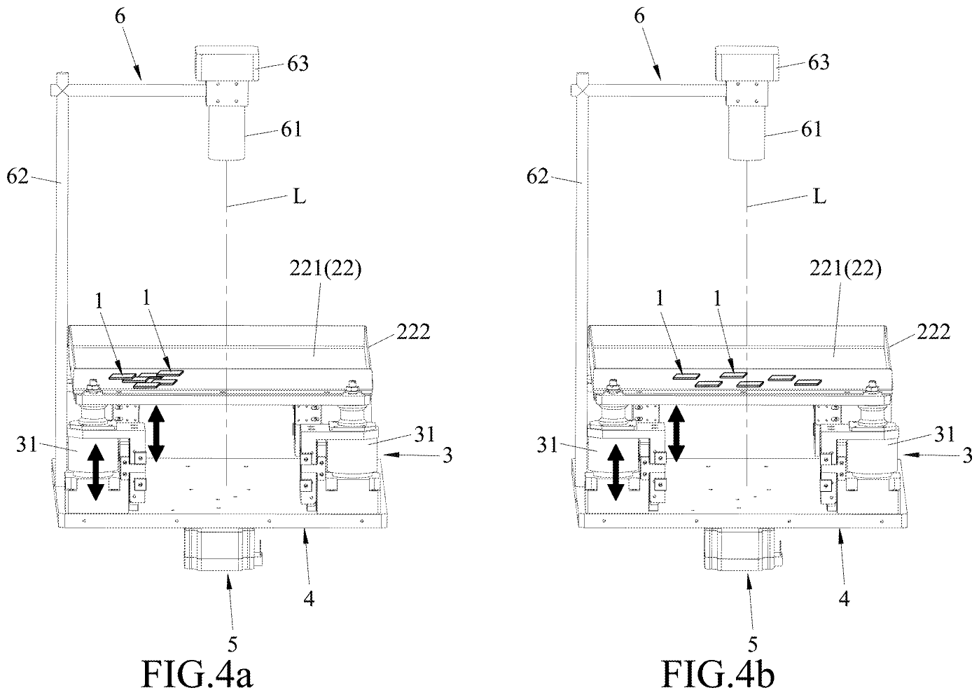

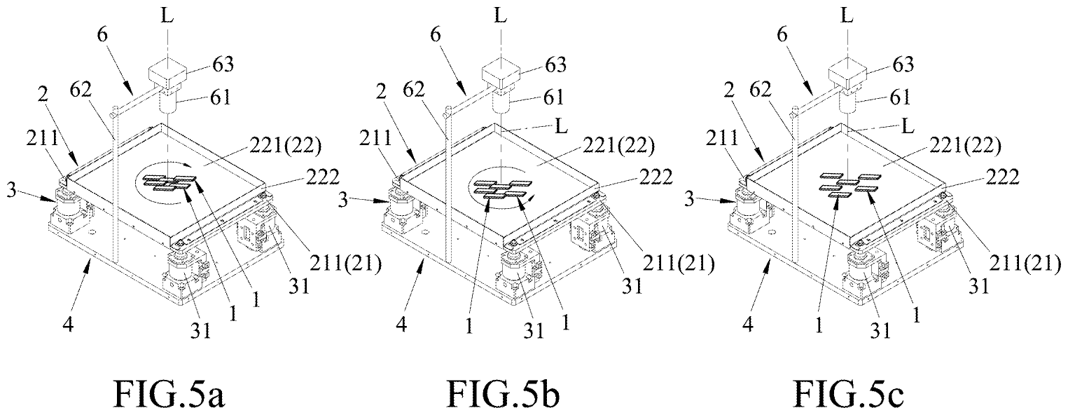

FIGS. 4a and 4b and FIGS. 5a, 5b and 5c illustrate the operation of the highly-efficient components supplying system to disentangle and separate the components 1. When it is merely desired to disentangle and separate the components 1 without the need to turn the components 1 to a specific posture, only the vibration actuating members 31 are operated to vibrate the placement surface 221 (see FIGS. 4a and 4b), or only the centrifugal actuating unit 5 is operated to rotate the placement surface 221 (see FIGS. 5a, 5b and 5c) to disentangle and separate the components 1.

As shown in FIG. 4a and FIG. 4b, when the components 1 are gathered at the left side of the placement surface 221, the placement surface 221 is vibrated by the two vibration actuating members 31 at the left side of FIG. 4a. Part of the components 1 are gradually moved rightwardly so as to disperse from one another to disentangle and separate the components 1 on the placement surface 221.

As shown in FIGS. 5a, 5b and 5c, when the components 1 are gathered at the central region of the placement surface 221, the placement surface 221 is rotated clockwise and counterclockwise alternately. The components 1 are gradually moved radially and outwardly due to a centrifugal force so as to disperse from one another to disentangle and separate the components 1 on the placement surface 221.

Furthermore, during the rotation of the placement surface 221 by the centrifugal actuating unit 5, the centrifugal force received by the components 1 on the placement surface 221 is proportional to the square of the angular velocity. A proper and sufficient centrifugal force is thus easily provided by the centrifugal actuating unit 5 for quickly disentangling and separating the components 1. Therefore, both the efficiency of disentangling and separation of the components 1 and the energy consumption rate during the supplying processes are relatively superior as compared with the conventional components supplying equipment that separates components by vertical vibration.

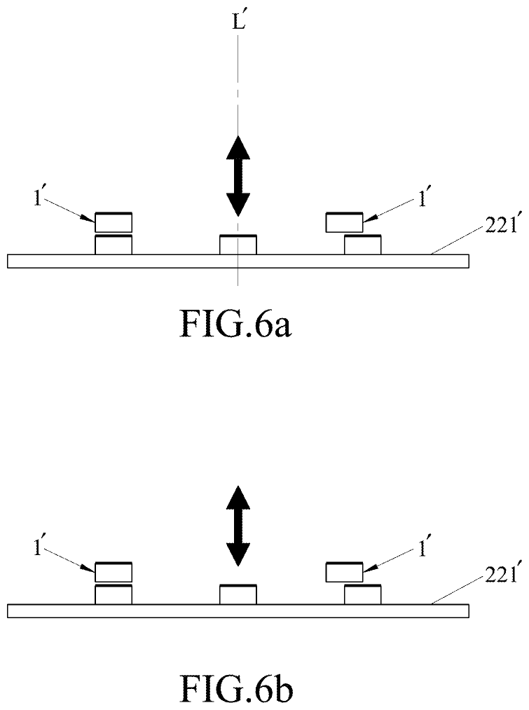

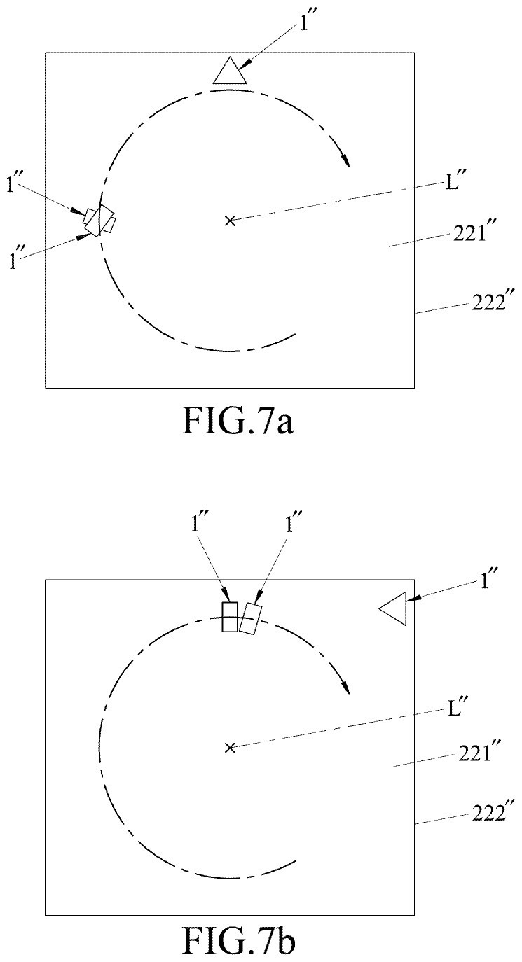

FIGS. 6a and 6b depict a first comparative example, and FIGS. 7a and 7b depict a second comparative example, in order to further illustrate the superior efficiency of the highly-efficient components supplying system having the vibration actuating members 31 and the centrifugal actuating unit 5, as shown in FIG. 3, and the improvement of disentangling and separating the components and turning over the components to a required posture.

In the first comparative example shown in FIGS. 6a and 6b, when a plurality of components 1′ are placed on a placement surface 221′, and are merely subjected to a vertical vibration force along a vertical axis (L′), the components 1′ are only moved upwardly away from the placement surface 221′ by the vertical vibration force, and then fall downward under the force of gravity. Therefore, the components 1′ are not turned over, and hence cannot be efficiently turned to the required posture for feeding processes.

In the second comparative example shown in FIGS. 7a and 7b, when a plurality of components 1″ are placed on a placement surface 221″, and are merely subjected to a rotational force about a vertical axis (L″), the components 1″ are only rotated about the axis (L″). Part of the components 1″ overlapping upon each other may be disentangled and separated from each other, but are not turned over efficiently and hence cannot present the required postures for feeding processes. Besides, in this example, during a rotation of the placement surface 221″, part of the components 1″ are liable to be stuck at the corner of the placement surface 221″ by a surrounding wall 222″ (for example, the component 1″ denoted by a triangle in FIGS. 7a and 7b), which renders the components 1″ not further movable by the rotating force.

The advantages of the highly-efficient components supplying system are summarized as follows:

1. With the vibration actuating members 31 and the centrifugal actuating unit 5, the vibration actuating members 31 vibrate the placement surface 221 at different regions to move the components 1 upward away from the placement surface 221 temporarily, and to generate torques with different directions as a result of the relative positions of the components 1 and the vibrated locations. And with the rotation of the platform unit 2 by the centrifugal actuating unit 5, the components 1 falling again on the placement surface 221 are moved again and turned to facilitate further disentangling and separation thereof and to have a required posture for feeding processes. When it is merely desired to disentangle and separate the components 1, due to the vibration actuating members 31 and the centrifugal actuating unit 5 operated individually and independently, all or part of the vibration actuating members 31 are controlled and operated to vibrate the placement surface 221, or the centrifugal actuating unit 5 is controlled and operated to rotate the placement surface 221, to disentangle and separate the components 1. Therefore, an optimized operation can be selected according to the characteristics and distribution of the components 1.

2. Since the centrifugal force received by the components 1 on the placement surface 221 is proportional to the square of the angular velocity during the rotation of the placement surface 221 by the centrifugal actuating unit 5, a proper and sufficient centrifugal force is easily provided by the centrifugal actuating unit 5 for quickly disentangling and separating the components 1. Therefore, both the efficiency of disentangling and separation of the components 1 and the energy consumption rate are relatively superior as compared with the conventional components supplying equipment that separates components by vertical vibration.

3. With the sensing and control unit 6 in which the processor 63 continuously analyzes the distribution of the components 1 and determines whether the components 1 present the required postures for feeding operations, the operation strokes of the vibration actuating members 31 and the centrifugal actuating unit 5 can be adjusted accordingly so as to more efficiently disentangle and separate the components 1 and so as to turn the components 1 to the required postures for feeding processes.

4. The processor 63 is stopped temporarily when it determines the positions and postures of the components 1 as reaching a predetermined condition that meets the feeding requirement, and controls and temporarily stops the operations of the vibration actuating members 31 and the centrifugal actuating unit 5 for a robot to perform grasp of the components 1. After the robot completes the grasp operation, the processor 63 controls and resumes the operations of the vibration actuating members 31 and the centrifugal actuating unit 5. Therefore, a highly automated operation can be realized to enhance the efficiency of disentangling and separation of the components 1 and making the components 1 present the required postures for feeding processes.

5. The vibration actuating members 31 are disposed on the platform unit 2 and are spaced apart from each other. Each vibration actuating member 31 is operable to vibrate individually the placement surface 221 in the extending direction of the axis (L) at the region corresponding with the position thereof. When the processor 63 determines that the components 1 are gathered on a region above one of the vibration actuating members 31, the processor 63 can drive the corresponding vibration actuating member 31 to operate independently, and stop operations of the remaining vibration actuating members 31 so as to efficiently disperse the gathered components 1.

The number of the vibration actuating members 31 may be varied to be two, three or more than four. In an alternative embodiment, the sensing and control unit 6 may have a sensor, such as a pressure sensor, to provide measurement to the processor 63 for analyzing the distribution information of the components 1 and determining whether the components 1 present the required postures.

As illustrated, with the vibration actuating members 31 and the centrifugal actuating unit 5, when each vibration actuating member 31 is operated to vibrate the placement surface 221, the components fare moved upwardly away from the placement surface 221 temporarily, and torques with different directions are generated as a result of the relative positions of the components 1 and the vibrated locations. Moreover, with the rotation of the platform unit 2 by the centrifugal actuating unit 5, the components 1 falling again on the placement surface 221 are moved again and turned to facilitate further disentangling and separation thereof and to have a required posture for feeding processes. Moreover, when it is merely desired to disentangle and separate the components 1, due to the vibration actuating members 31 and the centrifugal actuating unit 5 operated individually and independently, all or part of the vibration actuating members 31 are controlled and operated to vibrate the placement surface 221, or the centrifugal actuating unit 5 is controlled and operated to rotate the placement surface 221, to disentangle and separate the components 1.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A highly-efficient components supplying system for transporting and feeding a plurality of components, comprising:
a platform unit having a placement surface for placement of the components and to which an axis is normal;
a vibration generating unit including a plurality of vibration actuating members which are disposed on said platform unit and spaced apart from each other, each of said vibration actuating members being operative to vibrate said placement surface in an extending direction of the axis;
abase seat which is spaced apart from said platform unit in the extending direction and on which said vibration actuating members are disposed; and
a centrifugal actuating unit disposed on said base seat and operative to make a synchronous rotation of said base seat, said vibration generating unit and said platform unit about the axis.

2. The highly-efficient components supplying system as claimed in claim 1, further comprising a sensing and control unit, said sensing and control unit arranged to correspond with said placement surface to detect and measure distribution and orientation of the components and generate a corresponding distribution information.

3. The highly-efficient components supplying system as claimed in claim 2, wherein said sensing and control unit includes a camera disposed above said placement surface to fetch images of said placement surface.

4. The highly-efficient components supplying system as claimed in claim 3, wherein said sensing and control unit further includes a processor in signal connection with said camera, said vibration generating unit and said centrifugal actuating unit, said processor being arranged to analyze the images fetched by said camera and generate the distribution information, and control operations of said vibration actuating members and said centrifugal actuating unit in accordance with the distribution information in either sequential or synchronous manner.

5. The highly-efficient components supplying system as claimed in claim 1, wherein said vibration actuating members are disposed under said platform unit and angularly spaced apart from each other about the axis.

6. The highly-efficient components supplying system as claimed in claim 5, wherein said vibration generating unit includes four of said vibration actuating members.

7. The highly-efficient components supplying system as claimed in claim 6, wherein said platform unit includes a base plate and a placement table mounted upon said base plate and having said placement surface, said base plate having two lateral flange portions which project laterally from two opposite sides of said placement table, respectively, two of said vibration actuating members being connected with a respective one of said lateral flange portions.

8. The highly-efficient components supplying system as claimed in claim 5, wherein said base seat is disposed under said platform unit, each of said vibration actuating members being interposed between and connected between said base seat and said platform unit, said centrifugal actuating unit being mounted under said base seat.
